(19) United States
(12) Patent Application Publication
(10) Pub. No.: US 2025/0316432 A1
(43) Pub. Date: Oct. 9, 2025

(54) SWITCHING DEVICE

(71) Applicant: TDK Electronics AG, Muenchen (DE)

(72) Inventors: Shun Yu, Schönefeld (DE); Robert Minkwitz, Berlin (DE); Rainer Morczinek, Kleinmachnow (DE); Frank Werner, Berlin (DE); Robert Hoffmann, Berlin (DE)

(21) Appl. No.: 18/863,301

(22) PCT Filed: May 11, 2023
(86) PCT No.: PCT/EP2023/062605

§ 371 Date: Nov. 5, 2024

(30) Foreign Application Priority Data
May 12, 2022 (DE) 10 2022 111 899.1
Feb. 20, 2023 (DE) 10 2023 104 121.5

(51) Int. Cl. H01H 50/54; H01H 50/18

(52) U.S. Cl. CPC H01H 50/541; H01H 50/18

(57) ABSTRACT

In an embodiment a switching device includes at least one fixed contact and a movable contact in a switching chamber, a contact element outside the switching chamber, a mechanical drive with a shaft, wherein the mechanical drive is configured for moving the movable contact and the contact element; and at least two auxiliary contacts outside the switching chamber on a side of the shaft facing away from the movable contact, wherein the contact element is configured to contact the at least two auxiliary contacts in a first switching state of the switching device and be spaced apart from the at least two auxiliary contacts in a second switching state of the switching device, or be spaced apart from the at least two auxiliary contacts in a first switching state of the switching device and contact the at least two auxiliary contacts in a second switching state of the switching device.

### CROSS-REFERENCE TO RELATED APPLICATIONS

This patent application is a national phase filing under section 371 of PCT/EP2023/062605, filed May 11, 2023, which claims the priority of German patent application no. 102022111899.1, filed May 12, 2022 and German patent application no. 102023104121.5, filed Feb. 20, 2023, each of which is incorporated herein by reference in its entirety.

### TECHNICAL FIELD

A switching device is specified.

### BACKGROUND

The switching device is configured in particular as an electromagnetically operated, remotely actuated switch that can be operated by an electrically conductive current. The switching device can be activated via a control circuit and can switch a load circuit. In particular, the switching device can be configured as a relay or as a contactor, in particular as a power contactor. Particularly preferably, the switching device can be configured as a gas-filled power contactor.

A possible application of such switching devices, in particular power contactors, is the opening and disconnecting of battery circuits, for example in motor vehicles such as electrically or partially electrically powered vehicles or in applications in the field of renewable energies.

In its function as a safety component, a contactor, for example, is normally additionally monitored, wherein contactor monitoring is regulated in the IEC 60947 May 1 standard. Contactor monitoring is intended, for example, to detect the most common fault in contactors, relays and switches, namely so-called sticking, i.e. welding of the main contacts. Such a fault, also known as contactor sticking, can be caused, for example, by electric arcs that form between the contacts during switching operations under load and can cause such high temperatures on the contact surfaces that the contact surfaces are welded together. It is also advantageous if other fault states can be detected, for example if a contact is mechanically blocked in an open position or in an intermediate state.

Typical contactors are designed as so-called overtravel systems. This means that after the main contacts have been interconnected by the switching bridge and thus electrically closed, the movement of the closing system is continued, wherein a usually springy pressure of the switching bridge increases on the main contacts. In the case of a contactor clip, this overtravel is reduced again, but the switching bridge remains attached to at least one main contact. The mechanical system thus hangs in an intermediate state and is neither open nor properly closed.

Monitoring or contactor sticking detection can be carried out, for example, by means of a voltage measurement via the main contacts of the contactor. If a voltage is present between the main contacts, the contactor is open. If there is no voltage, it follows that the contactor is short-circuited and therefore closed. Although this method is very safe, it is also expensive to use, as cables that carry high-voltage potential have to be laid and insulated accordingly. Monitoring is usually carried out by a higher-level system, such as a microcontroller-controlled analog-to-digital converter.

It is also known, for example, to use a microswitch in the switching chamber of the contactor, which is operated by a small arm on the switching bridge. The arm actuates the switch shortly before the switching bridge is pressed against the main contacts. The switch can be designed as a normally open contact (closed when pressed) or as a normally closed contact (open when pressed). The signal of the microswitch can therefore also be inverted compared to the switching state of the contactor. One disadvantage of this solution is that the microswitch must be mounted close to the main contacts inside the switching chamber. This can sometimes affect arc quenching or result in insulation disadvantages. Furthermore, the monitoring contact formed by the cantilever and microswitch must have a leading design. This means that the monitoring contact changes its state before the main contact closes. This is because the microswitch must still indicate the “closed” state if the overtravel has already been used up during a sticking. This means that intermediate states or blockages cannot be detected. Another disadvantage is the service life of conventional microswitches, which can only be a few 100,000 switching cycles, depending on the design. Furthermore, supply lines must be laid to the switch, which restricts the use of completely hermetically sealed ceramic discharge chambers.

Furthermore, an auxiliary switch is known from publication WO 2008/033349 A2, for example, which is operated via a bracket on the switching bridge, wherein two overlapping contacts can be pressed together, for example. The solution is simple, inexpensive and virtually wear-free. However, it has the disadvantage that the overlapping contacts are fitted between the main contacts, which can lead to insulation problems. Furthermore, supply lines must be laid to the auxiliary switch, which restricts or prevents the use of completely hermetically sealed ceramic discharge chambers. The switching behavior is still similar to that of the microswitch.

In order to circumvent the described disadvantages, it is also known to attach a magnet to the lower part of the moving system and in particular outside the switching chamber, which can open and close a reed switch, as described for example in the publication JP 2013-008621 A. As a result, detection takes place far away from the main contacts and detection can also take place through non-magnetic materials. This solution is also easy to use in conjunction with hermetically sealed ceramic discharge chambers. The switching behavior is analogous to the two systems described above, but there is the difficulty of setting the correct overlap range, as the indication is magnetic and hysteresis effects must also be taken into account. Another disadvantage is the sensitivity of the reed switch to magnetic interference fields and mechanical shocks.

As an improvement on this, it is known to use a Hall sensor instead of the reed switch, so that magnetic detection is not carried out by a mechanical switch but by a semiconductor component. As a result, magnetic interference fields no longer play a role and there is no longer any dependence on vibration. However, the switching behavior is similar to that of the reed switch.

All four monitoring switch solutions have a so-called “normally open” characteristic, i.e. the monitoring switch largely reflects the status of the main contacts. However, inverting the signal does not produce a “normally closed”, but only a “not normally open”. What all four principles have in common is that none of these solutions can reliably signal that the monitored contactor is safely and fully open. However, such a requirement is formulated in the IEC 60947Apr. 1 standard, which requires detection that only closes a monitoring contact or indicates a closed monitoring contact (“normally closed”) when the contactor is at rest. Such a solution is not yet known for gas-filled contactors.

In the publications EP 2 843 683 A1 and EP 3 471 127 A1, it is proposed to provide an additional intermediate chamber with monitoring contacts between the switching chamber and the area with the switching actuator, through which the options “normally open” and “normally closed” can be freely selected. The disadvantage of this variant is that the intermediate chamber requires more space, which can have a negative effect on the weight, size and cost of the contactor. The arrangement of monitoring contacts in the switching chamber, which then have to be routed out of the switching chamber and protected from arcing by plastic shields, for example, can also lead to a larger space requirement in order to maintain the necessary insulation distances between the high-voltage parts and the low-voltage parts.

### SUMMARY

Embodiments provide a switching device.

According to at least one embodiment, a switching device has at least one fixed contact and at least one movable contact. The at least one fixed contact and the at least one movable contact are intended and configured to switch a load circuit, which can be connected to the switching device, on and off. Particularly preferably, the switching device has at least two fixed contacts which, together with the movable contact, are intended and configured to switch on and off a load circuit that can be connected to the switching device and, in particular, to the at least two fixed contacts. In the following, the switching device is mostly described with two fixed contacts. However, in the following embodiments as well as with regard to the features described below, the number of fixed contacts may differ from the numbers specifically mentioned.

The movable contact can be moved in the switching device between a non-through-connecting state and a through-connecting state of the switching device in such a way that, in the non-through-connecting state of the switching device, the movable contact is at a distance from the at least one or the at least two fixed contacts and is thus galvanically isolated and, in the through-connecting state, has mechanical contact with the at least one or the at least two fixed contacts and is thus galvanically through-connecting to them. In the through-connecting state, the movable contact thus makes contact with the at least one or the at least two fixed contacts. In the case of at least two fixed contacts, the fixed contacts are thus arranged separately from one another in the switching device and, depending on the state of the movable contact, can be electrically conductively connected to one another or electrically separated from one another by the movable contact. In the through-connecting state, the movable contact touches at least one contact surface of each of the fixed contacts with at least one contact surface. The distance between the movable contact, in particular said contact surface of the movable contact, and the fixed contacts, in particular said contact surfaces of the fixed contacts, in the non-through-connecting and thus disconnected state is also referred to here and in the following as the switching gap or switching path and indicates the maximum range of movement of the movable contact and thus the maximum achievable distance between the fixed contacts and the movable contact and in particular their contact surfaces.

According to a further embodiment, the switching device has a switching chamber in which the movable contact and the at least one or the at least two fixed contacts are arranged. In particular, the movable contact can be arranged completely in the switching chamber. The fact that a fixed contact is arranged in the switching chamber can mean in particular that at least a contact region of the fixed contact, which is in mechanical contact with the movable contact in the through-through-connecting state, is arranged inside the switching chamber. To connect a supply line of a circuit to be switched by the switching device, a fixed contact arranged in the switching chamber can be electrically contacted from the outside, i.e. from outside the switching chamber. For this purpose, a fixed contact arranged in the switching chamber can protrude with a part out of the switching chamber and have a connection option for a supply line outside the switching chamber. The switching chamber thus preferably has openings through which the fixed contacts protrude into the switching chamber. The fixed contacts are soldered into the openings of the switching chamber, for example, and protrude both into the interior of the switching chamber and out of the switching chamber.

In particular, the switching chamber can have an interior that is surrounded by a switching chamber wall. For example, the switching chamber can have a switching chamber cover and a switching chamber base, which can preferably completely surround the interior. This includes the case where there are openings in the switching chamber cover and/or in the switching chamber base through which elements such as the fixed contacts protrude into the switching chamber and thus into the interior.

According to a further embodiment, the switching device has at least two auxiliary contacts which are arranged outside the switching chamber. The fact that the auxiliary contacts are arranged outside the switching chamber can mean in particular that the auxiliary contacts are arranged outside the interior of the switching chamber and thus do not protrude into the switching chamber.

According to a further embodiment, the switching device has at least one contact element that is arranged outside the switching chamber. In other words, the contact element, like the auxiliary contacts, is arranged outside the interior of the switching chamber.

According to a further embodiment, the contact element is movable together with the movable contact. Particularly preferably, the contact element and the movable contact can be moved together with the same mechanical drive, which is described further below. Preferably, the at least two auxiliary contacts are arranged outside the switching chamber on a side of the mechanical drive facing away from the movable contact.

According to a further embodiment, the contact element contacts the at least two auxiliary contacts in a first switching state of the switching device. In other words, in this case the contact element is mechanically and thus also electrically in contact with the at least two auxiliary contacts in the first switching state. The at least two auxiliary contacts are preferably electrically connected to each other by the contact element and thus short-circuited. Furthermore, the contact element can be arranged at a distance from the auxiliary contacts in a second switching state. The first switching state can particularly preferably be the above-described non-through-connecting switching state of the switching device, while the second switching state can be the above-described through-connecting state. In other words, the contact element can contact the auxiliary contacts in this case when the movable contact is spaced apart from the at least one fixed contact, while the contact element is spaced apart from the at least two auxiliary contacts when the movable contact of the switching device contacts the at least one fixed contact. If an electrical contact is detected between the auxiliary contacts in this case, this means that the switching device is in a non-through-connecting state. In this case, the monitoring contact formed by the auxiliary contacts and the contact element therefore has a “normally closed” characteristic as described above.

Alternatively, it is also possible that the first switching state is also the through-connecting switching state, while the second switching state is the non-through-connecting state. In this case, the mode of operation of the detection of a switching device state made possible by the auxiliary contacts is reversed with respect to the following description and corresponds to the “normally open” configuration. Furthermore, it is possible that the contact element is arranged at a distance from the auxiliary contacts in the first switching state of the switching device, the first switching state being the non-through-connecting state of the switching device, and the contact element contacts the auxiliary contacts in the second switching state of the switching device, which is then the through-connecting state of the switching device. Thus, in this embodiment, the contact element then contacts the at least two auxiliary contacts in the second switching state of the switching device. In other words, the contact element is then mechanically and thus also electrically in contact with the at least two auxiliary contacts in the second switching state. Consequently, in this embodiment, the contact element is spaced apart from the at least two auxiliary contacts when the movable contact is spaced apart from the at least one fixed contact, while the contact element can contact the auxiliary contacts when the movable contact of the switching device contacts the at least one fixed contact. If an electrical contact is detected between the auxiliary contacts, this means in this embodiment that the switching device is in a through-connecting state. The monitoring contact formed by the auxiliary contacts and the contact element represents the state of the switching contacts and has a “normally open” characteristic.

According to a further embodiment, the switching device has a housing in which the movable contact, the fixed contacts, the auxiliary contacts and the contact element are arranged. Furthermore, the switching chamber is located inside the housing. The fact that a fixed contact is arranged in the housing can mean in particular that at least a contact region of the fixed contact, which is in mechanical contact with the movable contact in the through-connecting state, is arranged inside the housing. To connect a supply line of a circuit to be switched by the switching device, a fixed contact arranged in the housing can be electrically contacted from the outside, i.e. from outside the housing. For this purpose, a part of a fixed contact arranged in the housing can protrude from the housing and have a connection option for a supply line outside the housing. In particular, this can apply to any fixed switching contact. In particular, the movable contact can be arranged completely in the housing. Furthermore, the auxiliary contacts can preferably also be arranged completely in the housing. The auxiliary contacts can be contacted from the outside via supply lines inside the housing, which are electrically conductively connected to external electrical connections on the housing, for example. Alternatively, an electrical component, such as a microcontroller or another electrical component for contacting and/or reading the auxiliary contacts, can be present in the housing and connected to the auxiliary contacts via electrical supply lines. The electrical component can in turn be contacted from the outside via suitable connections on the housing.

According to a further embodiment, the contacts are arranged in a gas atmosphere in the housing. In particular, the gas atmosphere can be enclosed in a gas-tight region of the switching device. The movable contact and the contact element can each be arranged completely in the gas atmosphere in the housing, whereas parts of the fixed contacts, such as the contact regions of the fixed contacts, and parts of the auxiliary contacts, such as contact regions of the auxiliary contacts, are arranged in the gas atmosphere in the housing. Accordingly, the at least two auxiliary contacts are arranged partly in the gas-tight region and partly outside the gas-tight region.

A part of the gas atmosphere is located inside the switching chamber. Another part of the gas atmosphere can be located outside the switching chamber. The switching chamber can thus be part of the gas-tight region, i.e. the region in which the gas is completely enclosed. Accordingly, the switching device can particularly preferably be a gas-filled switching device such as a gas-filled contactor. The gas-tight region preferably has a wall, which can be multi-part and can have wall regions made of different materials. For example, a part of the switching chamber, such as a switching chamber cover, can form part of the wall of the gas-tight region. In this case, the switching chamber cover can preferably be made of a gas-tight material, for example a ceramic material. Furthermore, the wall of the gas-tight region can have wall regions that are, for example, with or made of stainless steel. Such a wall region with or made of stainless steel can, for example, be soldered or welded to the switching chamber lid in a gas-tight manner.

Furthermore, the at least two auxiliary contacts can be arranged in a ceramic element and protrude through the ceramic element. For this purpose, the ceramic element can have openings, wherein an auxiliary contact is arranged in each opening and is particularly preferably brazed to an edge of the openings. Each of the auxiliary contacts can have a flange for this purpose, which has a fastening region with which the auxiliary contact is brazed to an edge area around the opening of the ceramic element. The term brazing solder is used here and in the following to refer to a solder that has a melting point of greater than or equal to 600° C. For example, a solder based on silver and/or copper can be used as a brazing solder, for example a silver-copper alloy such as Ag72Cu28. The ceramic element can form part of the wall of the gas-tight region and can be connected to a wall region which comprises or is made of stainless steel or another non-magnetic or slightly magnetic alloy. Such a wall region with or made of stainless steel can, for example, be soldered or welded to the ceramic element in a gas-tight manner. The ceramic element and the wall region connected to it can together form a cup shape. In particular, the ceramic element can form a base of the cup shape, while the wall region connected to the ceramic element has at least one cylindrical part that forms a side wall of the cup shape. In particular, the magnetic core can be guided in the cup formed by the cup shape.

In particular, the gas atmosphere can promote the extinguishing of arcs that may occur during switching operations. The gas of the gas atmosphere can, for example, be a gas containing hydrogen and/or nitrogen, in particular under high pressure. Preferably, the gas can have a proportion of at least 50% H₂. In addition to hydrogen, the gas may comprise an inert gas, particularly preferably N₂ and/or one or more noble gases.

According to a further embodiment, the movable contact and the contact element are movable by means of a mechanical drive. In particular, this can mean that the contact element is arranged and, in particular, attached to an element of the mechanical drive that causes a switching movement of the movable contact. The mechanical drive can, for example, be a linear drive or a rotary drive. The switching movement of the movable contact from the first to the second switching state and back can thus be a linear movement or a rotary movement. Accordingly, the contact element can also perform such a movement during the transition from the first to the second switching state and vice versa.

In particular, the mechanical drive can have a shaft. The auxiliary contacts can be arranged particularly preferably on a side of the shaft facing away from the movable contact. In other words, the shaft can have a first end, at which the movable contact is arranged and particularly preferably mounted directly or indirectly, and a second end, at the side of which the auxiliary contacts are arranged. The contact element can thus be mounted directly or indirectly at the second end of the shaft. The contact element and the movable contact can thus be arranged at opposite ends of the shaft. In particular, the shaft can protrude into the switching chamber through an opening in the switching chamber. For example, the switching chamber can have a switching chamber base that has an opening through which the shaft protrudes.

For example, the mechanical drive can be configured as a rotary drive and have a stepper motor that can rotate through a defined angle, preferably around an axis of rotation defined by the shaft, in incremental steps. The shaft can be part of the motor, for example. Furthermore, the drive unit can have a magnetic drive that has a rotatable magnet armature that can be rotated by a magnetic circuit in order to affect the switching operations described above. For this purpose, the magnetic circuit can have a yoke. In particular, the rotatable magnetic armature may have the shaft. Furthermore, the armature can have a magnetic core, which is configured as a magnetic rotating core, which can be attached to an end of the shaft opposite the movable contact and which is part of the magnetic circuit. A coil, which can be connected to a control circuit, can be used to generate a magnetic field in the magnetic circuit, which rotates the armature.

Furthermore, the mechanical drive can be configured as a linear drive that can affect a linear stroke movement, in particular along the shaft. In this case, the mechanical drive particularly preferably has an armature that can be moved linearly by a magnetic circuit in order to affect the switching operations described above. For this purpose, the magnetic circuit can have a yoke with an opening through which the shaft of the armature protrudes. When the magnetic circuit is switched on, the magnetic armature, in particular a magnetic core of the magnetic armature, can be pulled towards the yoke. In particular, the magnetic core can be attached to an end of the shaft opposite the movable contact and be part of the magnetic circuit.

According to a further embodiment, the auxiliary contacts and/or the contact element have a material with copper or a copper alloy. The material is particularly preferably one that has a good electrical conductivity and a low tendency to weld. The material is particularly preferably selected from CuBe, CuSn₄ and CuSn₆. Furthermore, the auxiliary contacts, for example, can have the same material as the fixed contacts and/or the movable contact.

According to a further embodiment, the contact element is at least partially springy. In other words, the contact element has resilient and thus elastic properties. Particularly preferably, the contact element or at least a part thereof is formed by a spring sheet, i.e. an at least partially plate-shaped and/or strip-shaped sheet which can be bent by the application of a force and can return to its original shape in the absence of this force.

The contact element is particularly preferably configured as a single piece, i.e. at least partially in the form of a metal band or metal strip, for example, and particularly preferably at least partially or completely in the form of a spring steel strip. In particular, the contact element can have a contact bar or contact ring, at least two connection bars extending away from the contact bar or contact ring, and a contact plate on each of the connection bars. The contact plates are preferably intended and configured up to be able to make mechanical contact with the auxiliary contacts. The connection bars can extend away from the contact bar or contact ring at an angle of essentially 90°. In the case of a contact bar, for example, the connection bars can have the same width as the contact bar.

The connection bars, the contact plates and the contact bar or contact ring can preferably be formed by a one-piece metal part. The one-piece metal part can be configured as a metal strip which has the contact bar, the connection bars and the contact plates as interconnected parts and which, for example, has a uniform width and can be bent in the shape of a rectangular U. Alternatively, the one-piece metal part can have the contact ring with at least two strips emerging from the contact ring, which are bent away from a main plane of extension of the contact ring and preferably form an angle of 90° or at least substantially 90° with the main plane of insertion of the contact ring.

Each connection bar can have a contact plate at the end facing away from the contact bar or contact ring, which can be inclined to the connection bar and can form an angle with the connection bar of greater than or equal to 90° or greater than or equal to 100° and less than or equal to 160° or less than or equal to 140° or less than or equal to 135°, for example. The contact plates can have a width that is greater than or equal to the width of the connection bar. For example, the contact plates can be semi-circular, e.g. semi-circular. In particular, the contact plates can face each other.

Furthermore, the contact plates can have a distance to each other that is smaller than the width of the auxiliary contacts. The width of the auxiliary contacts refers in particular to the width of the contact surfaces of the auxiliary contacts and can be measured in a direction along which the distance between the contact plates is also measured. The contact plates can thus preferably cover as large an area as possible, for example essentially circular, apart from a slit with a width corresponding to the aforementioned distance.

Furthermore, the contact element can have a plurality of connection bars which are arranged around the contact ring, separated by slits, and extend away from the contact ring, with a contact plate being arranged on each of the connection bars. The connection bars can be arranged on an outer edge of the contact ring or on an inner edge of the contact ring.

The contact element can be attached directly to the shaft, for example. If the mechanical drive has a magnetic core as described above, it is particularly preferable for the contact element to be attached to the magnetic core. In this case, the contact element is particularly preferably attached directly to the magnetic core. In particular, the contact bar or contact ring can be attached to the magnetic core. Preferably, the contact element, i.e. particularly preferably the contact bar or contact ring, can be welded to the magnetic core. The magnetic core can have a recess in which a part of the contact element, in particular the contact bar or contact ring, is arranged. The connection bars can protrude from the recess.

If the mechanical drive is configured as a magnetic drive, the contact element can be surrounded by a coil of the magnetic drive. Furthermore, the at least two auxiliary contacts can also be surrounded by this coil. In other words, the coil can, for example, be arranged around a cylindrical, continuous opening in which the contact element and/or the at least two auxiliary contacts are arranged.

In the case of a mechanical actuator configured as a linear actuator, this can have a return spring which, when the electromagnet is switched off, can cause or at least support a movement of the armature from the second switching position back to the first switching position. The return spring can have a return spring force RFK and the contact element can have a spring force FK, where FK<RFK, so that the spring force of the contact element is less than the force that the return spring exerts on the armature. FK/RFK≤0.2 is particularly preferred, so that the switching movement is not restricted by the contact element. The return spring and the contact element can exert a force on the armature in the same direction or in opposite directions, wherein in both cases preferably FK/RFK≤0.2 applies in both cases.

Furthermore, the movable contact can cover a switching path SW during the transition from the first switching state to the second switching state in order to close the switching gap. The mechanical drive and thus preferably the armature can close a magnetic gap MS during the transition from the first switching state to the second switching state, i.e. cover a path with the length MS, where MS is at least equal to SW and MS>SW is particularly preferred. The path that the contact element must cover in order for the contact element to lose or make mechanical contact with the at least two auxiliary contacts can be referred to as the contact path KW. The contact path KW is preferably smaller than the switching path SW and smaller than the magnetic gap MS. Particularly preferred is therefore KW<SW and KW<MS. The mechanical drive and thus preferably the armature can also cover the path MS during the transition from the second switching state to the first switching state, wherein the contact element can lose mechanical contact to the at least two auxiliary contacts preferably after a path of less than or equal to 0.2×MS or less than or equal to 0.1×MS in the event that the contact element contacts the auxiliary contacts in the second switching state of the switching device.

In the switching device described here, it can be achieved that the at least two auxiliary contacts are electrically connected to each other by the contact element in the first switching state and electrically separated from each other in the second switching state. By measuring the electrical resistance between the auxiliary contacts, the first switching state, which particularly preferably corresponds to the non-connecting switching state, can thus be reliably determined. In accordance with IEC 60947 May 1, the described configuration of the switching device also enables detection of the “switching device cannot close” fault state, i.e. a state in which the switching device is blocked in the open position. Furthermore, even if the upper part of the switching device, in which the switching chamber is arranged, is destroyed, it is still possible to detect whether the switching device is in the non-closing state and the switching contacts have thus been opened.

Alternatively, in the reverse configuration described above, it can be achieved that the at least two auxiliary contacts with the contact element map the switching state of the main contacts, i.e. the movable contact and the at least one fixed contact. In this case, the state of the auxiliary contacts, i.e. electrically connected to each other or electrically disconnected from each other, therefore preferably always corresponds to the state of the main contacts.

The switching device described here can also be manufactured very cost-effectively, i.e. without high additional costs, as no additional electronic components, for example in the form of additional circuitry and/or in the form of ICs, are required. Furthermore, no magnetic influence on the monitoring contact formed by the auxiliary contacts and the contact element is possible, as can be the case with reed switches or Hall switches, for example. It can also be achieved that a mechanical influence on the monitoring contact by shocks follows the properties of the moving system, i.e. the monitoring contact would also correctly indicate the “not fully open” state after a lift-off due to acceleration. The fact that the auxiliary contacts are not located in the switching chamber means that any arcing that occurs there cannot damage the arrangement forming the monitoring contact. On the other hand, the components used have no negative influence on the extinguishing behavior in the switching chamber.

### BRIEF DESCRIPTION OF THE DRAWINGS

Further advantages, advantageous embodiments and further developments are revealed by the embodiments described below in connection with the figures.

FIGS. 1A to 1H show schematic illustrations of a switching device and parts thereof according to an embodiment;

FIGS. 2A to 2D show schematic illustrations of parts of the switching device according to further embodiments;

FIGS. 3A and 3B show schematic illustrations of the switching device of FIGS. 1A to 1H in an intermediate state;

FIGS. 4A to 4F show schematic illustrations of the switching device and of parts thereof according to a further embodiment;

FIGS. 5A and 5B show schematic illustrations of auxiliary contacts of a switching device according to further embodiments; and

FIGS. 6A to 6C show schematic illustrations of parts of the switching device according to a further embodiment.

In the embodiments and figures, identical, similar or identically acting elements are provided in each case with the same reference numerals. The elements illustrated and their size ratios to one another should not be regarded as being to scale, but rather individual elements, such as for example layers, components, devices and regions, may have been made exaggeratedly large to illustrate them better and/or to aid comprehension.

### DETAILED DESCRIPTION OF ILLUSTRATIVE EMBODIMENTS

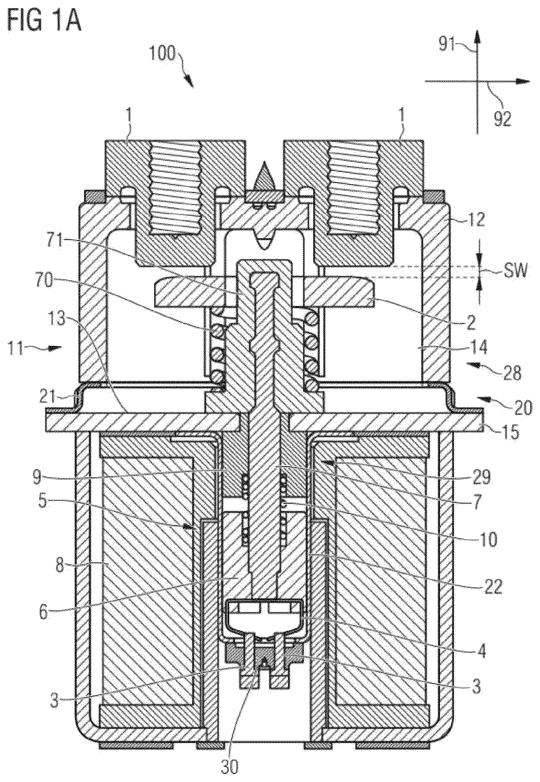

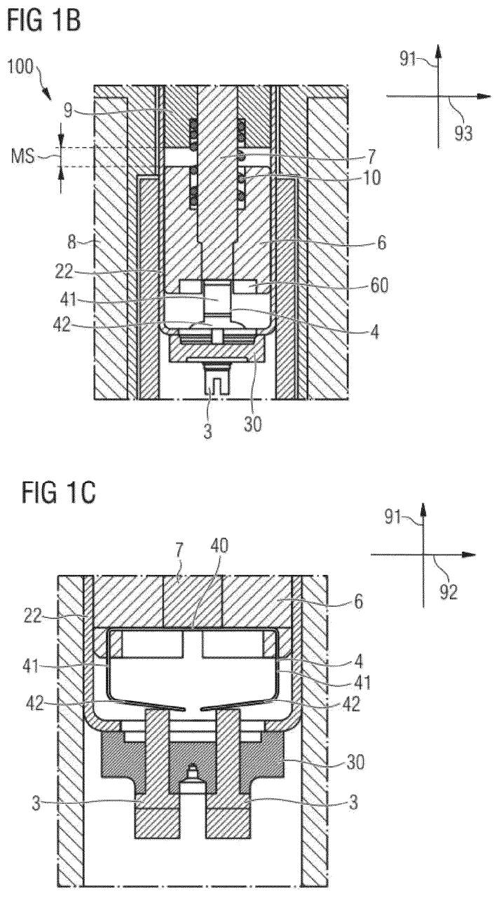

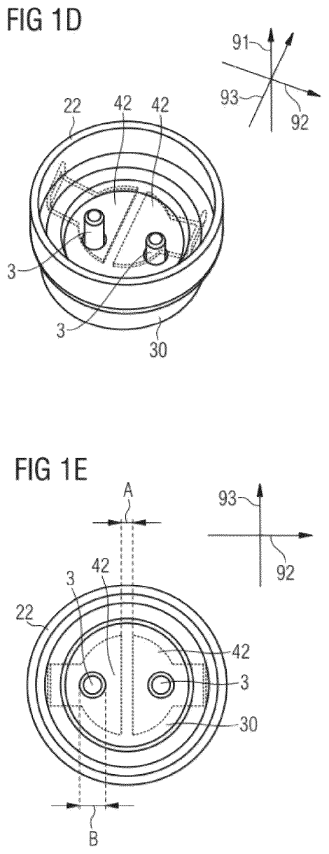

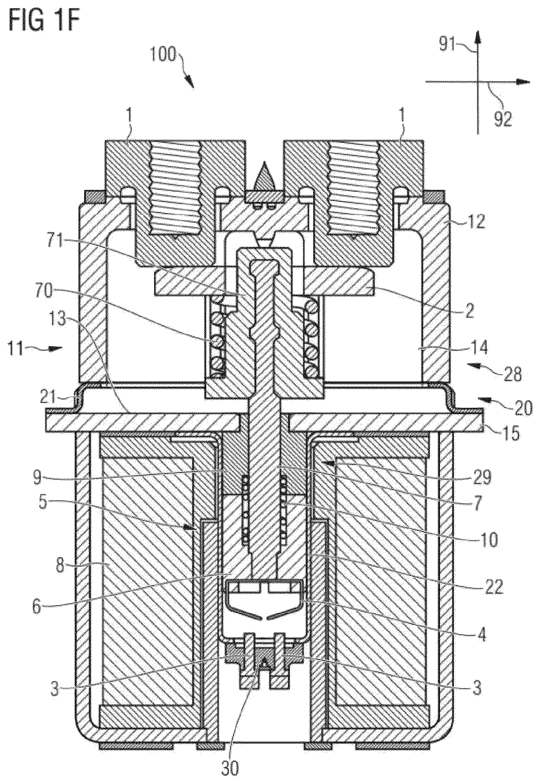

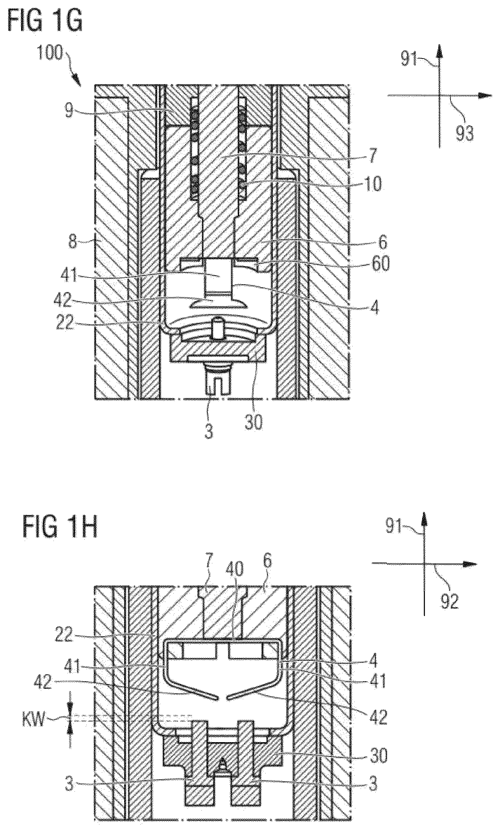

FIGS. 1A to 1H show an embodiment of a switching device 100 which can be used, for example, for switching strong electrical currents and/or high electrical voltages and which can be a relay or contactor, in particular a power contactor. In FIGS. 1A and 1F, the switching device 100 is shown in different switching states, in each case in a sectional view with a vertical sectional plane. In FIGS. 1B and 1G, the switching device 100 is shown in the corresponding switching states, in each case in a section of a cut-away view along a further vertical sectional plane perpendicular thereto. FIGS. 1C and 1H show sections of the illustrations shown in FIGS. 1A and 1F. FIGS. 1D and 1E show views of a part of the gas-tight region of the switching device 100. The geometries shown are only exemplary and are not to be understood as limiting and can also be embodied alternatively.

The switching device 100 has two fixed contacts 1 and a movable contact 2 in a housing (not shown). The movable contact 2 is configured as a contact plate. Together with the movable contact 2, the fixed contacts 1 form the switching contacts of the switching device 100, which can also be referred to as main contacts and through which a load circuit that can be connected to the fixed contacts 1 can be opened and closed. As an alternative to the number of switching contacts shown, other numbers of fixed and/or movable contacts may also be possible. Furthermore, the configuration of the switching contacts shown and in particular their geometry is purely exemplary and are not to be understood as limiting. Alternatively, the switching contacts can also be embodied differently.

The housing (not shown), in which preferably all shown components of the switching device 100 are arranged except for an upper part of each of the fixed contacts 1, serves primarily as contact protection for the components arranged inside and has a plastic or is made of plastic, for example polybutylene terephthalate (PBT) or glass-fiber-filled PBT. The fixed contacts 1 and/or the movable contact 2 can, for example, be made of or with Cu, a Cu alloy, one or more refractory metals such as Wo, Ni and/or Cr, or a mixture of the aforementioned materials, for example copper with at least one other metal, for example Wo, Ni and/or Cr.

In FIGS. 1A to 1C, the switching device 100 is shown in a rest state in which the movable contact 2 is spaced apart from the fixed contacts 1 so that the contacts 1, 2 are electrically isolated from each other. The rest state is also referred to below as the first switching state, which is a non-through-connecting state of the switching device 100. A load circuit connected to the fixed contacts 1 of the switching device 100 would therefore be open in this switching state. In FIGS. 1F to 1H, the switching device 100 is shown in a second switching state, which is a through-connecting state of the switching device 100. In the second switching state, the fixed contacts 1 and the movable contact 2 are in mechanical contact with each other and are thus galvanically connected, so that a load circuit connected to the switching device 100 would be closed.

The switching device 100 has a mechanical drive for carrying out the switching movements, which in the embodiment shown is configured purely exemplary as a lifting drive, so that the movable contact 2 carries out a linear movement when changing from the first to the second switching state and vice versa, which in the embodiment shown runs along a vertical direction 91. In particular, the mechanical drive is configured as a magnetic drive and has a movable armature 5, which essentially performs the switching movement. The armature 5 has a magnetic core 6, for example with or made of a ferromagnetic material. Furthermore, the armature 5 has a shaft 7 which is guided through the magnetic core 6 and is firmly connected to the magnetic core 6 at one end of the shaft. At the other end of the shaft opposite the magnetic core 6, the armature 5 has the movable contact 2, which is mounted via a contact spring 70 and is also connected to the shaft 7. The shaft 7 can preferably be made of stainless steel. To electrically insulate the movable contact 2 from the shaft 7, an electrically insulating contact holder 71, which can also be referred to as a bridge insulator, can be arranged between them.

The magnetic core 6 is surrounded by a coil 8, which forms the essential part of an electromagnet. A current flow in the coil 8, which can be switched on externally by a control circuit, generates a movement of the magnetic core 6 and thus of the entire armature 5 in the axial direction, i.e. along the main direction of extension of the shaft 7 and thus in the vertical direction 91, so that the movable contact 2 makes contact with the fixed contacts 1. In the illustration shown, the armature 5 moves upwards. The armature 5 thus moves from a first position, which corresponds to the rest state shown and at the same time to the disconnecting, i.e. non-through-connecting and thus switched-off switching state, to a second position, which corresponds to the active, i.e. through-connecting and thus switched-on switching state of the switching device 100.

To guide the shaft 7 and thus the armature 5 and to form a magnetic circuit with the magnetic core 6 and the coil 8, the switching device 100 further comprises a yoke 9, which may comprise or be made of pure iron or a low-doped iron alloy and which forms part of the magnetic circuit. The yoke 9 has an opening in which the shaft 7 is guided. Furthermore, a sleeve or bushing, for example made of a plastic material, can also be arranged in the opening of the yoke 9 to guide the shaft 7. If the current flow in the coil 8 is interrupted, the armature 5 is moved back into the first position by a return spring 10. In the illustration shown, the armature 5 thus moves downwards again. The switching device 100 is then back in the rest state, in which the contacts 1, 2 are open. Instead of just one return spring 10, several return springs can also be present, which can act like an effective return spring with an effective return spring force.

As described, the direction of movement of the armature 5 and thus of the movable contact 2 is the direction designated as vertical direction 91. Unless otherwise specified, designations such as “up” or “down” refer to the vertical direction 91. In this sense, the armature 5 and thus the movable contact 2 therefore move upwards during the transition from the first to the second switching state of the switching device 100 and downwards again during the transition from the second switching state to the first switching state. A plane perpendicular to the vertical direction 91 is referred to as a lateral plane. Directions perpendicular to the vertical direction 91 can generally be referred to as lateral directions, wherein the lateral direction along which the fixed contacts 1 are arranged is also referred to as longitudinal direction 92. The lateral direction perpendicular to the vertical direction 91 and perpendicular to the longitudinal direction 92 is also referred to as the transversal direction 93. The directions 91, 92 and 93, which also apply independently of the switching movement described, are indicated in the figures to facilitate orientation.

For example, when opening the contacts 1, 2, at least one electric arc can occur, which can damage the contact surfaces of the contacts 1, 2. As a result, there may be a risk that the contacts 1, 2 “stick” to each other due to welding caused by the electric arc and can no longer be separated from each other. The switching device 100 is then still in the switched-on state, although the current in the coil 8 is switched off and the load circuit should therefore be disconnected. In order to prevent the formation of such arcs or at least to support the extinguishing of arcs that occur, the contacts 1, 2 are arranged in a gas atmosphere, so that the switching device 100 is configured as a gas-filled relay or gas-filled contactor. For this purpose, the contacts 1 are arranged within a switching chamber 11, formed by a switching chamber cover 12 and a switching chamber base 13, which is part of a gas-tight region 20 formed by a hermetically sealed part. The gas-tight region 14 is essentially formed by parts of the switching chamber 11 and the yoke 9 and by additional wall regions 21, 22. The gas-tight region 20 completely surrounds the armature 5 and the contacts 1, 2 except for parts of the fixed contacts 1 intended for external connection. The gas-tight region 20 and thus also an interior 14 of the switching chamber 11 are filled with a gas. The gas, which can be filled into the gas-tight region 20 through a gas filling nozzle, for example in the switching chamber cover 12, as part of the manufacture of the switching device 100, can be particularly preferably hydrogen-containing, for example with 20% or more H₂ in an inert gas or even with 100% H₂, since hydrogen-containing gas can promote the extinguishing of arcs.

Inside or outside the switching chamber 11, permanent magnets (not shown), so-called blow magnets, for example, can also be present, which are intended and configured to deflect the arcs. In particular, the blow magnets extend the arc path and can therefore improve the extinguishing of the arcs.

The switching chamber cover 12 can, for example, be made with or from a ceramic material, such as a metal oxide like Al₂O₃. In the embodiment shown, the switching chamber base 13 is formed by a flange 15 in which the yoke 9 is arranged and which forms part of the magnetic circuit. The flange 15 can be made of iron or steel. Alternatively, as described further below, the switching chamber base 13 can also be formed by an additional component between the switching chamber cover 12 and the flange 15.

Furthermore, the switching device 100 has at least two auxiliary contacts 3, which are arranged outside the switching chamber 11. In particular, the at least two auxiliary contacts 3 are arranged outside the switching chamber 11 on a side of the mechanical drive facing away from the movable contact 2 and thus the shaft 7. As an alternative to the configuration shown with two auxiliary contacts 3, the switching device 100 can also have more than two auxiliary contacts 3, for which the following description applies accordingly. As shown in FIGS. 1A to 1H, the auxiliary contacts 3 can be arranged along the longitudinal direction 92 in the same way as the fixed contacts 1. Alternatively, it is also possible to arrange the auxiliary contacts 3 along a different lateral direction, for example along the transversal direction 93 or along a direction between the longitudinal direction 92 and the transversal direction 93.

The switching device 100 further comprises at least one contact element 4, which is arranged outside the switching chamber 11. In particular, the contact element 4 is arranged outside the switching chamber 11 on a side of the mechanical drive facing away from the movable contact 2 and thus the shaft 7. The contact element 4 can be moved together with the movable contact 2. In particular, the contact element 4 and the movable contact 2 are movable together with the same mechanical drive according to the previous description. The contact element 4 is arranged within the gas-tight region 20.

The gas-tight region 20 essentially has an upper region 28, which is formed above the flange 15 by the switching chamber 11, and a lower region 29, which is arranged below the flange 15 and in which the magnetic core 6 of the armature 5 is arranged. The auxiliary contacts 3 and the contact element 4 are thus arranged in the lower region 29 of the gas-tight region 20.

In the first switching state of the switching device 100, as can be seen in FIGS. 1A to 1C, the contact element 4 contacts the at least two auxiliary contacts 3. Thus, in the first switching state, the contact element 4 is mechanically and thus also electrically in contact with the at least two auxiliary contacts 3. In the second switching state, as can be seen in FIGS. 1F to 1H, the contact element 4 is arranged at a distance from the auxiliary contacts 3. Thus, the contact element 4 can contact the auxiliary contacts 3 when the switching device 100 is in the rest state and the movable contact 2 is at a distance from the fixed contacts 1, while the contact element 4 is at a distance from the at least two auxiliary contacts 3 when the movable contact 2 of the switching device 100 contacts the fixed contacts 1 and the switching device 100 is in the through-connecting state.

The at least two auxiliary contacts 2 are electrically connected to each other by the contact element 4 and thus short-circuited. If an electrical contact is detected between the auxiliary contacts 3, this means that the switching device 100 is in a non-through-connecting state. The auxiliary contacts 3 and the contact element 4 thus form a monitoring contact that has a “normally closed” characteristic. Alternatively, it is also possible that the first switching state is also the switching state that switches on, while the second switching state is the state that does not switch on. In this case, the mode of operation of the detection of a state of the switching device made possible by the auxiliary contacts is reversed and corresponds to the “normally open” configuration.

The auxiliary contacts 3 are arranged in a ceramic element 30 and protrude through the ceramic element 30. For this purpose, the ceramic element 30 has openings, with an auxiliary contact 3 being arranged in each opening, which is particularly preferably brazed to an edge of the respective opening 39. The auxiliary contacts 3 can, for example, have a flange with a fastening region, which is fastened to the ceramic element 30, for example by soldering such as brazing. The auxiliary contacts 3 are electrically insulated from each other by means of the ceramic element 30. The ceramic element 30 can, for example, be made of a metal oxide such as Al₂O₃.

In particular, the ceramic element 30 forms part of the wall of the gas-tight region 20. Adjacent to the ceramic element 30, the gas-tight region 20 has a wall region 22 which has stainless steel or is made of stainless steel and which is brazed to the ceramic element 30 in a gas-tight manner by means of a brazing solder or is welded to the ceramic element 30. The wall region 22 can, for example, have nickel-plated stainless steel or be made of stainless steel. The ceramic element 30 is configured as a ceramic plate, for example, i.e. as a ceramic disk with a circular cross-section in the lateral plane. For fastening the auxiliary contacts 30 and the wall region 22, the ceramic element can each have mounting areas which are formed, for example, by raised circumferential surface areas, as can be seen, for example, in FIGS. 1C and 1H.

The auxiliary contacts 3 and/or the contact element 4 can be made of a material containing copper or a copper alloy. The material is particularly preferably one that has a good electrical conductivity and a poor tendency to weld. The material is particularly preferably selected from CuBe, CuSn₄ and CuSn₆. Furthermore, the auxiliary contacts 3, for example, can have the same material as the fixed contacts 1 and/or the movable contact 2.

In the embodiment shown, the ceramic element 30 and the wall region 22 connected thereto together form a cup shape, the ceramic element 30 being essentially disc-shaped as described above and forming a base of the cup shape, while the wall region 22 connected to the ceramic element 30 has a cylindrical part which forms a side wall of the cup shape. In particular, the magnetic core 6 can be guided in the cup formed by the cup shape.

As described, the ceramic element 30 is intended and configured to hermetically seal the gas space formed by the gas-tight region 20 at the bottom and to electrically insulate the auxiliary contacts 30 from each other and from any other electrical potential in the switching device 100. The auxiliary contacts 3 are fed through into the gas-tight region 20 by means of a hermetically sealed and particularly preferably brazed connection from the wall region 22, which can also be referred to as the pot, to the ceramic element 30 and from the ceramic element 30 to the auxiliary contacts 3. The brazed connections described can be carried out in a common process step. The pot formed by the wall region 22 with the ceramic element 30 and the auxiliary contacts 3 can then be welded to the flange 15, for example by laser welding, to form the lower region 29 of the gas-tight region 20.

The contact element 4 is particularly preferably configured as a single piece. As can be seen in the figures, the contact element 4 can be configured, for example, in the form of a metal strip or metal strip, particularly preferably in the form of a spring steel strip. In particular, the contact element 4 has a contact bar 40, two connection bars 41 extending away from the contact bar 40 and a contact plate 42 on each of the connection bars 41. The connection bars 41 can particularly preferably extend away from the contact bar 40 at an angle of essentially 90° and, for example, have the same width as the contact bar 40. The connection bars 41 and the contact bar 40 can thus be formed by a metal strip or a metal band, which has a uniform width and is bent in the shape of a rectangular U. Each connection bar 41 has a contact plate 42 at the end facing away from the contact bar 40, which is particularly preferably inclined to the corresponding connection bar 41 and can form an angle with the latter of greater than or equal to 90° or greater than or equal to 10° and less than or equal to 160° or less than or equal to 140° or less than or equal to 135°, for example. For example, each contact plate can form an angle of 110° with the connection bar on which it is arranged. The contact plates 42, which are intended and configured to make mechanical contact with the auxiliary contacts 3 in the first switching state, preferably have a width that is greater than or equal to the width of the connection bars 41. As shown, the contact plates 42 can particularly preferably be semicircular in shape, so that the largest possible area of the contact element 30 can be covered by the contact plates 42 without the contact plates 42 being in direct mechanical contact with one another. In particular, the contact plates 42 face each other and have a slit with a distance A between them that is smaller than a width B of the auxiliary contacts 3, i.e. in particular smaller than a width of the contact surfaces of the auxiliary contacts 3 that contact the contact element 4. The width B of the auxiliary contacts 3 is preferably measured in a direction along which the distance A of the contact plates 42 is also measured, i.e. along the longitudinal direction 92 in the orientation shown in FIGS. 1A to 1H.

The contact element 4 can, for example, be attached directly to the shaft 7. Preferably, the contact element 4 is attached to the magnetic core 6. In this case, the contact element 4 is particularly preferably attached directly to the magnetic core 6. For example, the contact element 4 can be welded to the shaft 7 or preferably to the magnetic core 6, for example by means of laser welding or resistance welding. In particular, the contact element 4 can be welded to the contact bar 40. As shown, the magnetic core 6 can have a recess 60 in which a part of the contact element 4, in particular the contact bar 40, is arranged. The connection bars 41 can protrude from the recess 60.

Due to the configuration of the mechanical drive described above, the coil 8 has a cylindrical, continuous opening which forms a cavity in which the magnetic core 6 is arranged. In particular, the previously described cup is arranged inserted into the coil 8. Thus, the contact element 4 and the auxiliary contacts 3 are also arranged in the cylindrical, continuous opening and surrounded by the coil 8. For the monitoring contact formed by the auxiliary contacts 3 and the contact element 4, the cavity in the coil 8, which is present due to the configuration, can thus be used without requiring additional space. This means that the small installation space in the coil opening below the switching chamber 11 can be optimally used.

The contact element 4 is at least partially springy and thus has resilient and thus elastic properties. Due to the fact that the contact element 4 is formed by a spring plate, at least in the region of the connection bars 41 and/or the contact plates 42, and thus by a plate-shaped and/or strip-shaped plate, it can be bent by the application of force and return to its original shape in the absence of this force. Due to the slit with the distance A described above, the contact plates 42 can be pressed in the direction of the contact bar 40 when placed on the auxiliary contacts 3 and thus spring-compressed. In the first switching state, the contact element 4 thus exerts a force on the auxiliary contacts 3 by means of spring pressure, through which a secure mechanical contact is achieved, which can also be maintained in the event of vibrations or impacts.

As described above, the mechanical drive configured as a linear actuator has a return spring 10 which, when the electromagnet is switched off, i.e. when the coil 8 is switched off, causes the armature 5 to move from the second switching position back to the first switching position. The return spring 10 has a return spring force RFK. If several return springs are present, these can be treated as one return spring with an effective return spring force RFK. To enable the armature 5 to return completely to the rest position, it is necessary for the contact element to have a spring force FK that is less than the return spring force RFK, i.e. that FK<RFK applies. Preferably, the spring force of the contact element 4 is significantly lower than the return spring force of the return spring 10, so that, for example, FK/RFK<0.5 applies and the switching movement is not restricted by the contact element. FK/RFK≤0.2 is particularly preferred.

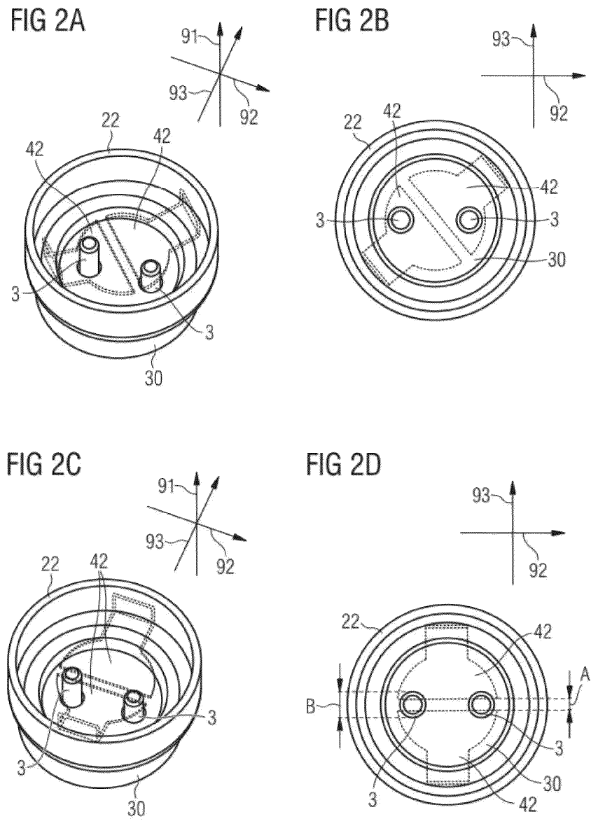

As can be seen in FIGS. 1D, 1E and 2A to 2D, the described essentially rotationally symmetrical structure of the contact plates 42 with a small distance A between them means that the positioning of the auxiliary contacts 3 relative to the contact element 4 is irrelevant, since any relative rotation of the contact element 4 to the auxiliary contacts 3 about the vertical shaft can ensure that the auxiliary contacts 3 can be short-circuited by the contact element 4. While FIGS. 1C and 1D show a non-rotated arrangement of the contact element 4 relative to the auxiliary contacts 3, FIGS. 2A and 2B show a rotation of 45° and FIGS. 2C and 2D show a rotation of 90° relative to the non-rotated arrangement. Even when twisted by 90°, the fact that the width B of the auxiliary contacts 3 is smaller than the distance A between the contact plates 42, as indicated in FIG. 2D, means that the auxiliary contacts 3 can be securely electrically connected to each other by the contact element 4. This enables a simplified assembly of the components of the switching device 100, as it allows a varying end position of the magnetic armature 6 to be taken into account. The mechanical drive can therefore also be a rotary drive, for example, instead of the linear drive described. Such a rotary drive is described in the publication DE 10 2019 126 351 A1, the disclosure of which is hereby incorporated by reference in its entirety. Instead of the auxiliary contacts in the switching chamber described in the publication DE 10 2019 126 351 A1, the auxiliary contacts described here and the contact element outside the switching chamber, for example at a lower end of the shaft, can be used. Even in such an embodiment, the semicircular contact plates 42 formed by contact spring plates are crucial, as they can always make contact with the auxiliary contacts 3 regardless of the rotation of the armature.

As indicated in FIG. 1A, the movable contact 2 must cover a switching path SW during the transition from the first switching state to the second switching state in order to close the switching gap. The path covered by the armature 5 is given by the magnetic gap MS between the magnetic core 6 and the yoke 9 in the rest position, as indicated in FIG. 1B. The path that the armature 5 and thus the contact element 4 must cover in order for the contact element 4 to lose mechanical contact with the at least two auxiliary contacts 3 can be referred to as the contact path KW and is indicated in FIG. 1H. The greater the deformation of the contact element 4 in the first switching state of the switching device 100, the greater the contact travel KW. The contact element 4 can only reliably lose contact with the auxiliary contacts 3 once it has fully returned to a non-deformed state. The contact travel KW is preferably significantly smaller than the switching path SW and then the magnetic gap MS in the rest position. This ensures that the distance that the movable contact system has to travel before the contact between the auxiliary contacts and the contact element breaks off is as small as possible. KW/SW≤0.2 is particularly preferred.

The armature with the movable contact 2 shown in FIGS. 1A to 1H is an overtravel system in which the movable contact 2 is slidably arranged on the contact holder 71. When the movable contact 2 strikes the fixed contacts 1 and thus when the switching gap is completely closed, the contact spring 70 can spring-compressed and the armature 5 can continue to move until, for example, the magnetic core 6 is in contact with the yoke 9 and the magnetic gap MS indicated in FIG. 1B is completely closed. For example, the magnetic core 6 can move upwards by a distance of less than or equal to 1 mm and particularly preferably of about 0.5 mm further than the movable contact 2 in the vertical direction 91. The compression of the contact spring 70 due to the overstroke can increase the contact pressure of the movable contact 2 on the fixed contacts 1 and a certain insensitivity to vibrations and mechanical shocks can be achieved. Therefore, KW/MS≤0.2 is also preferable, where MS denotes the magnetic gap in the first switching state.

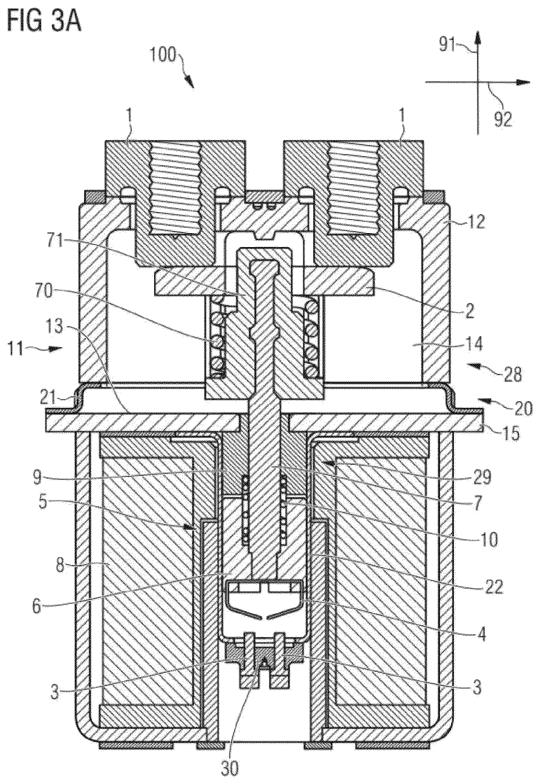

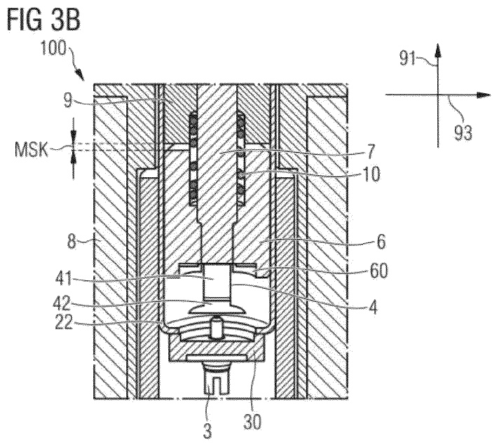

If the switching device 100 is to be returned to the first switching state in the second switching state and if the contacts 1, 2 are stuck together, i.e. if the movable contact 2 is welded to at least one of the fixed contacts 1, which can also be referred to as “tack welding”, the movable contact 2 remains in the through-connecting switching state even though the coil 8 is switched off. Only the overtravel can be reduced by the return spring 10, so that a small magnetic gap MSK is created between the magnetic core 6 and the yoke 9, while the switching gap remains closed. This state is shown in FIGS. 3A and 3B in views corresponding to FIGS. 1A and 1B. The armature 5 remains suspended in this state, which thus forms an intermediate state. Due to the short contact path of the contact element 4 described above, the auxiliary contacts 3 are still spaced apart from the contact element 4, so that it can be reliably detected at the auxiliary contacts 3 that the first switching state has not yet been reached. As a result, the malfunction of the switching device 100 can be reliably detected. The switching device 100 described thus fulfills the above-mentioned standard requirement of detecting the “safely open” state with a simple mechanism for detecting and for conducting the signal out of a hermetically sealed gas chamber in the lower region 29 of the switching device 100. The auxiliary contacts 3 are protected from arcing in the upper region 28, i.e. the switching chamber 11.

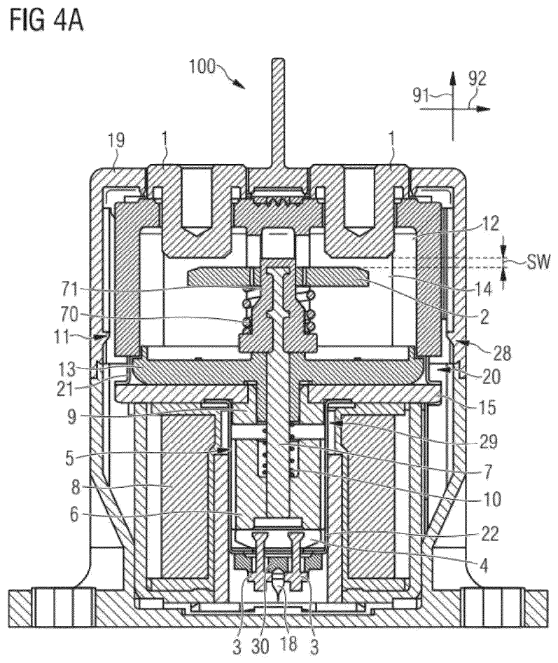

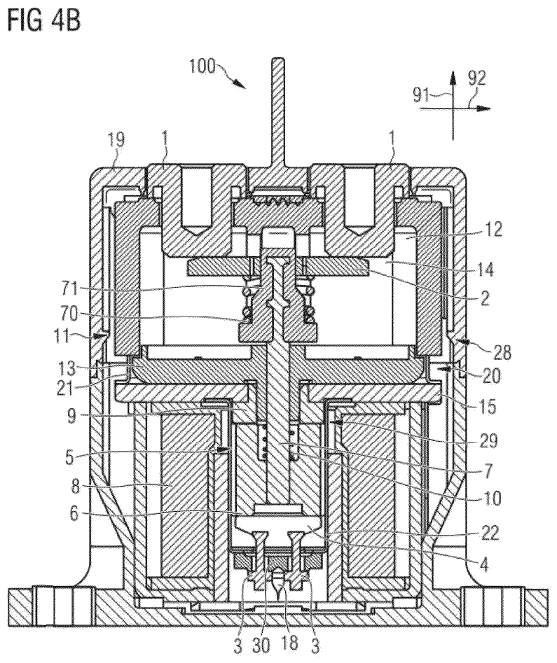

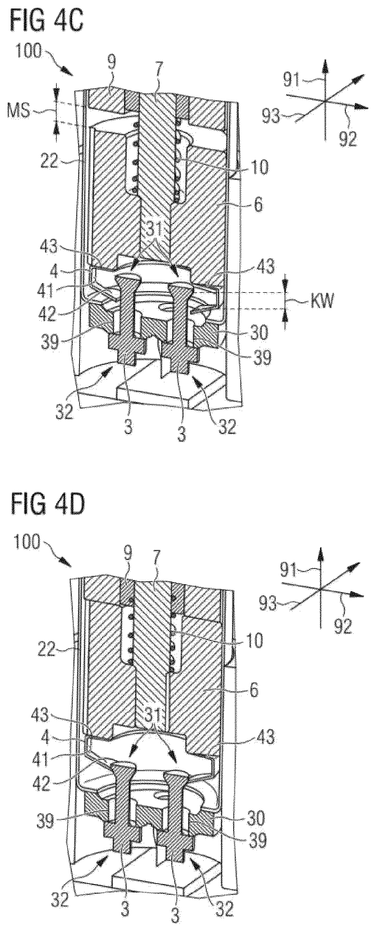

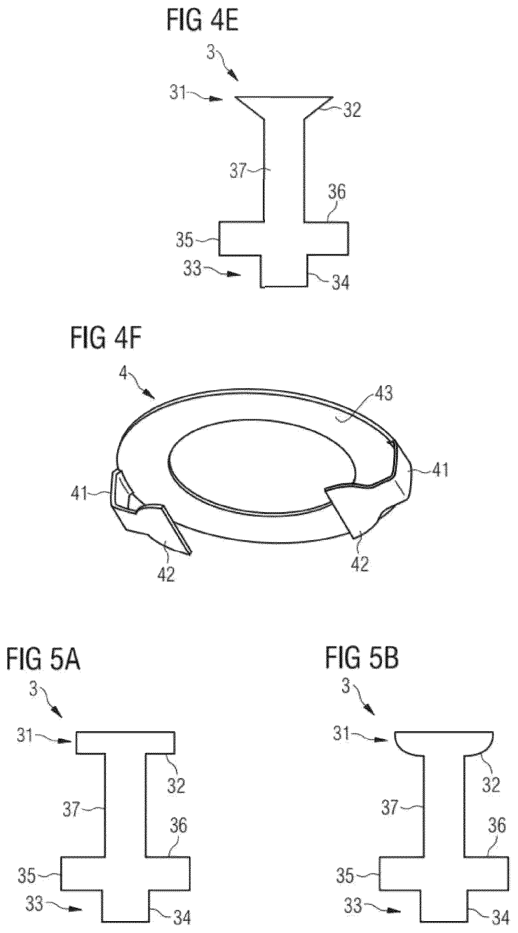

FIGS. 4A to 4F show a further embodiment of the switching device 100. In FIG. 4A, the switching device 100 is shown in a sectional view with a vertical sectional plane. In this representation, the switching device 100 is in a first switching state. In FIG. 4B, the switching device 100 is shown in a second switching state. FIGS. 4C and 4D show sections of the switching device 100 in the first switching state and in the second switching state, respectively, in a sectional view. FIGS. 4E and 4F show an auxiliary contact 3 and a contact element 4 of the switching device 100. The following description refers equally to FIGS. 4A to 4F, mainly describing the differences from the previous embodiments. Features and components not described below may be embodied in accordance with the previous description.

Like the switching device 100 according to the previous description, the switching device 100 shown in FIGS. 4A to 4F has, in a housing indicated by the reference sign 19, two fixed contacts 1 and a movable contact 2, which is configured as a contact plate, as switching contacts. The housing 19, in which preferably all other components of the switching device 100 shown are arranged except for an upper part of the fixed contacts 1 in each case, serves primarily as contact protection for the components arranged inside and can be embodied as described above.

In FIGS. 4A and 4C, the switching device 100 is shown in the rest state, in which the movable contact 2 is spaced apart from the fixed contacts 1, which is also referred to as the first switching state in this embodiment, which is a non-through-connecting state of the switching device 100. In FIGS. 4B and 4D, the switching device 100 is in the second switching state, which is a through-connecting state of the switching device 100.

Compared to the previous embodiments, the switching chamber base 13 is formed as an additional element and is arranged on the flange 15 in which the yoke 9 is arranged. Compared to the previously described switching device 100, the switching chamber base 13 can thus be formed as shown by a component between the switching chamber cover 12 and the flange 15, which preferably covers the flange 15 and has an opening through which the shaft 7 protrudes. A ceramic material or, in particular, plastics with a sufficiently high temperature resistance, for example a polyether ether ketone (PEEK), a polyethylene (PE) and/or a glass fiber-filled PBT, are suitable for such a switching chamber base. Alternatively or additionally, the switching chamber 11, in particular a switching chamber base, may also at least partially comprise a polyoxymethylene (POM), in particular with the structure (CH₂O)ₙ. Such a plastic can be characterized by a comparatively low carbon content and a very low tendency to form graphite. Due to the equal proportions of carbon and oxygen, particularly in (CH₂O)ₙ, gaseous CO and H₂ can predominantly be produced during heat-induced and, in particular, arc-induced decomposition. The additional hydrogen can increase arc extinction.

Furthermore, as described in connection with the previous embodiments, the switching device 100 has at least two auxiliary contacts 3 and at least one contact element 4, which are arranged outside the switching chamber 11. As described above, the auxiliary contacts 3 are arranged in openings 39 in a ceramic element 30 and protrude through the ceramic element 30. An auxiliary contact 3 is arranged in each opening 39, which is particularly preferably brazed to an edge of the respective opening 39. As indicated in FIG. 4E by means of a schematic representation of an auxiliary contact 3, the auxiliary contacts 3 have a flange 35 with a fastening region 36, which is fastened to the ceramic element 30. The fastening region 36 of each of the auxiliary contacts 3 is thus soldered to the ceramic element 30 at an edge area around the respective opening 39.

Furthermore, as indicated in FIGS. 4A to 4D, a further opening may be present in the ceramic element 30, in which a gas filling nozzle 18 is arranged and particularly preferably also soldered in and via which the gas-tight region 20 can be filled with a gas as described above as part of the manufacture of the switching device 100. The gas filling nozzle 18 can be closed after filling, for example by soldering or crimping.

As described in connection with the previous embodiments, the contact element 4 is particularly preferably formed in one piece. As can be seen in particular in FIG. 4F, the contact element 4 of the embodiment of FIGS. 4A to 4F can have a contact ring 43 instead of a contact bar described above. Furthermore, as in the previous embodiments, the contact element 4 has at least two connection bars 41 and a contact plate 42 on each of the connection bars 41. The connection bars 41 extend away from the contact ring 43. Even if the contact element 4 is described here and in the following always with a contact ring 43 instead of the contact ring 43, there can also be, for example, a contact bar as described above, which connects the connection bars 41 in a straight line, or a contact plate, which is configured as a circular disk, for example. In particular, the features described below for the contact ring 43 can also apply to a contact bar or a contact plate.

At least parts of the contact element 4, such as the connection bars 41 and the contact plates 42 or even the entire contact element 4, can be formed from a spring plate as described above. The contact ring 43 is preferably flat and can have a main extension plane. The connection bars 41 can particularly preferably extend at an angle of essentially 90° away from the main plane of extension and thus away from the contact ring 43. The connection bars 41 and the contact ring 43 can thus be formed by a metal part which has the contact ring 43 with at least two strips emerging from the contact ring 43, which are bent away from a main extension plane of the contact ring 43 and preferably form an angle of 90° or at least substantially 90° with the main extension plane of the contact ring 43. At the end facing away from the contact ring 43, each connection bar 41 has a contact plate 42, which is particularly preferably inclined to the corresponding connection bar 41 and can form an angle with the latter of greater than or equal to 90° or greater than or equal to 100° and less than or equal to 160° or less than or equal to 140° or less than or equal to 135°, for example. For example, each contact plate can form an angle of 110° with the connection bar on which it is arranged. The contact plates 42, which are intended and arranged to make mechanical contact with the auxiliary contacts 3 in the second switching state, preferably have a width that is greater than or equal to the width of the connection bars 41. As shown, the contact plates 42 can particularly preferably be semi-circular in shape. In particular, the contact plates 42 face each other.

The contact element 4 is attached to the magnetic core 6 as in the previous embodiments. In particular, the contact element 4 may be welded to the magnetic core 6, for example with the contact ring 43. As shown, the magnetic core 6 can have an annular raised area on which the contact ring 43 is arranged and attached.

Unlike in the previous embodiments, the contact element 4 does not contact the at least two auxiliary contacts 3 in the first switching state of the switching device 100, as can be seen in FIGS. 4A and 4C, and is thus spaced apart from the auxiliary contacts 3. Thus, in the first switching state, the contact element 4 is mechanically and thus also electrically not in contact with the at least two auxiliary contacts 3. In the second switching state, as can be seen in FIGS. 4B and 4D, the contact element 4 contacts the auxiliary contacts 3 and is thus mechanically and electrically in contact with the auxiliary contacts 3. Thus, the contact element 4 is spaced apart from the at least two auxiliary contacts 3 when the switching device 100 is in the rest state and the movable contact 2 is spaced apart from the fixed contacts 1, while the contact element 4 can contact the auxiliary contacts 3 when the movable contact 2 of the switching device 100 contacts the fixed contacts 1 and the switching device 100 is in the through-connecting state. The contact element 4 electrically connects the at least two auxiliary contacts 2 to each other and thus short-circuits them. If an electrical contact is detected between the auxiliary contacts 3, this means in the embodiment shown that the switching device 100 is in a through-connecting state. The auxiliary contacts 3 and the contact element 4 thus form a monitoring contact which has a “normally open” characteristic and which represents the state of the main contacts 1, 2.

As can be seen in particular in FIGS. 4C and 4D, in the first switching state of the switching device 100, at least part of the contact element 4 is arranged laterally next to the at least two auxiliary contacts 3. In particular, the contact plates 42 and at least parts of the connection bars 41 can be arranged laterally next to the auxiliary contacts 3. Each of the at least two auxiliary contacts 3 has an upper end section 31 facing the shaft 7, wherein the contact plates 42 are arranged below the upper end sections 31 as seen from the shaft 7, irrespective of the switching state of the switching device 100, i.e. both in the first switching state and in the second switching state. In other words, the upper end portion 31 of each of the auxiliary contacts 3 is arranged above the contact plates 42 in the vertical direction 91. Each of the auxiliary contacts 3 has a contact region 32, as indicated in FIG. 4E. The contact regions 32 of the auxiliary contacts 3 are arranged in the upper end section 31 and, in the second switching state of the switching device 100, are each mechanically and thus also electrically contacted by a contact plate 42 of the contact element 4, as is indicated in FIGS. 4B and 4D. At least in the second switching state of the switching device 100, each of the contact regions 32 is arranged between the contact ring 43 and the contact plate 42 mechanically contacting the contact region 32. Since the contact plates 42 are arranged below the upper end sections 31, the contact regions 32 of the auxiliary contacts 3 point downwards and thus away from the shaft 7.

As can be seen in FIGS. 4A to 4E, the contact regions 32 of the auxiliary contacts 3 can be configured in the form of a conical shell. The above-described inclined arrangement of the contact plates 42 relative to the connection bars 41 makes it possible to achieve good mechanical and thus also electrical contact between the auxiliary contacts 3 and the contact element 4.

On the side opposite the upper end portion 31, each auxiliary contact 3 has a lower end portion 33 which is adjacent to the flange 35 and which has a connection region 34 via which each of the auxiliary contacts 3 can be connected outside the gas-tight region 20 via supply leads. The distance of the contact region 32 of each auxiliary contact 3 from the ceramic element 30 is essentially determined by the length of a connecting area 37 between the upper end section 31 and the lower end section 33. During the switching operations of the switching device 100, the contact plates 42 move along the connecting areas 37 of the auxiliary contacts 3 until they each meet a contact region 32.

As described in connection with the previous embodiments, the contact element 4 is at least partially springy and thus has resilient and thus elastic properties. Due to the fact that the contact element 4 is formed by a spring plate at least in the region of the connection bars 41 and/or the contact plates 42, and thus by a plate-shaped and/or strip-shaped plate, it can be bent by the application of a force and return to its original shape in the absence of this force. During the transition from the first to the second switching state of the switching device 100, the contact plates 42 can be pressed away from the contact ring 43 when placed on auxiliary contacts 3, i.e. in particular the contact regions 32 of the auxiliary contacts 3, and during the further movement of the contact element 4. As a result, the contact plates 42 and/or the connection bars 41 can bend elastically, so that the contact plates 42 are pressed against the contact regions 32. In the second switching state, the contact element 4 thus exerts a force on the auxiliary contacts 3 by means of spring pressure, through which a secure mechanical contact is achieved, which can also be maintained in the event of vibrations or impacts.

As described above, the mechanical actuator configured as a linear actuator has a return spring 10 with a return spring force RFK, which causes the armature 5 to move from the second switching position back to the first switching position when the electromagnet is switched off. The contact element 4 can have a spring force FK. Preferably, FK<RFK and particularly preferably FK/RFK≤0.2, so that the switching movement is not or at least not significantly influenced by the contact element and the spring force of the contact element does not interfere with the force effect of the mechanical drive during the transition from the first to the second switching operation. As a result, it may be possible for the return spring 10 and the mechanical drive to be optimally designed regardless of whether the auxiliary contacts 3 and the contact element 4 are installed in the switching device 100 or not.

As described above in connection with the previous embodiments and also indicated in FIG. 4A, the movable contact 2 must cover a switching path SW during the transition from the first switching state to the second switching state in order to close the switching gap, as shown in FIG. 4B. The path covered by the armature 5 is given by the magnetic gap MS between the magnetic core 6 and the yoke 9 in the rest position, as indicated in FIG. 1C. The path that the armature 5 and thus the contact element 4 must cover in order for the contact element 4 to come into mechanical contact with the at least two auxiliary contacts 3 can also be referred to as the contact path KW in the present embodiment and is also indicated in FIG. 4C. The contact path KW is preferably smaller than the switching path SW and then the magnetic gap MS in the rest position. This allows the movable system to continue moving after contact has been made between the auxiliary contacts 3 and the contact element 4, so that the contact plates 42 are pressed against the contact regions 32 of the auxiliary contacts 3 as described above. KW<SW and KW<MS are therefore particularly preferred. The mechanical drive and thus preferably the armature 5 can also cover the distance MS during the transition from the second switching state to the first switching state, wherein the contact element 4 can preferably lose mechanical contact with the at least two auxiliary contacts 3 after a distance of less than or equal to 0.2×MS or less than or equal to 0.1×MS.

In the present embodiment, the armature 5 with the movable contact 2 is also an overtravel system, in which the movable contact 2 is slidably arranged on the contact holder 71. When the movable contact 2 strikes the fixed contacts 1 and thus when the switching gap is completely closed, the contact spring 70 can become spring-compressed, as already described in connection with the previous embodiments, and the magnetic armature 5 can move further until, for example, the magnetic core 6 rests against the yoke 9 and the magnetic gap MS indicated in FIG. 4B is completely closed, as shown in FIG. 4D. Particularly preferably, the magnetic core 6 can move upwards by a distance of less than or equal to 1 mm and particularly preferably of about 0.5 mm further than the movable contact 2 in the vertical direction 91, so that the contact pressure of the movable contact 2 on the fixed contacts 1 can be increased by the compression of the contact spring 70 due to the overstroke and a certain insensitivity to vibrations and mechanical shocks can be achieved.

If the switching device 100 is to be transferred back to the first switching state in the second switching state and if the contacts 1, 2 are stuck together, only the overtravel can be reduced as described above, so that only a small magnetic gap MSK is created between the magnetic core 6 and the yoke 9, while the switching gap remains closed and the armature 5 remains stuck in this intermediate state. Due to the contact path KW of the contact element 4 described above, which is smaller than the size of the magnetic gap MS in the first switching state, the auxiliary contacts 3 are preferably still contacted by the contact element 4, so that it can be reliably detected at the auxiliary contacts 3 that the second switching state is still present and the first switching state has not yet been reached. Since the contact element 4 only loses mechanical contact with the auxiliary contacts 3 after the distance MS-KW covered by the magnetic core 6 when the armature 5 moves downwards, i.e. in the direction from the second to the first switching state, MSK<MS−KW is particularly preferable. As a result, the malfunction of the switching device 100 can be reliably detected.

As in the previous embodiments, the switching device 100 described in connection with FIGS. 4A to 4F has a simple mechanism for detecting the switching state and for conducting the signal out of a hermetically sealed gas chamber in the lower region 29 of the switching device 100. In this embodiment, the auxiliary contacts 3 are also protected from arcing in the upper region 28, i.e. the switching chamber 11.

As shown in FIGS. 5A and 5B, the contact region 32 of each of the auxiliary contacts 3 can have a conical shell shape other than that described in connection with the embodiment of FIGS. 4A to 4F, as long as the upper end area 31 forms an overhang with the contact surface 32, which is arranged in the movement path of the associated contact plate of the contact element in such a way that the contact plate can move past the connection region 37 of the auxiliary contact 3 and abuts against the contact surface 32 after covering the contact path KW. For example, the contact surface 32 can be configured horizontally, as indicated in FIG. 5A, so that the connecting region 37 with the upper end region 31 can have a T-shaped cross-section in a section through the auxiliary contact 3 with a vertical sectional plane. Furthermore, the contact surface 32 can also have a round cross-section in a section through the auxiliary contact 3 with a vertical sectional plane, as indicated in FIG. 5B, and can, for example, be formed as part of a spherical surface.

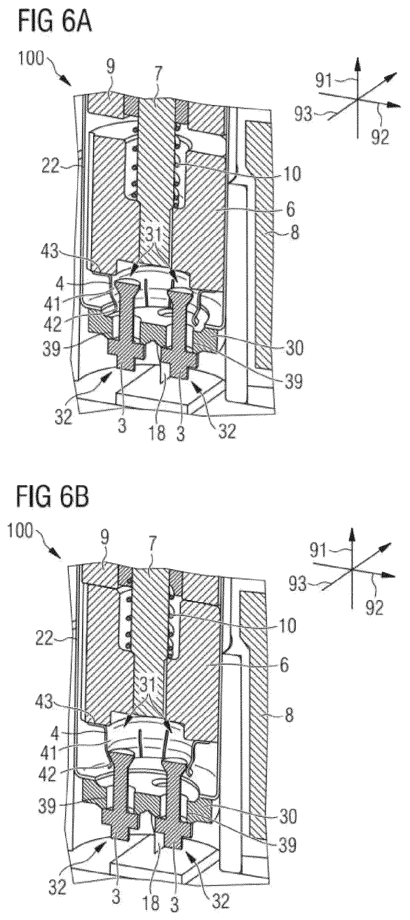

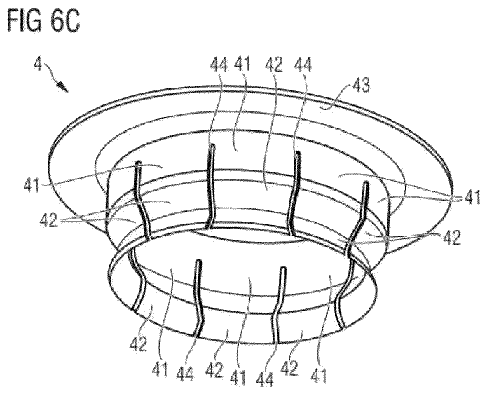

The auxiliary contacts 3 and the contact element 4 of the embodiment described in connection with FIGS. 4A to 4F must be installed in the switching device 100 in the correct position with respect to each other, so that the contact plates 42 are in the correct position with respect to the auxiliary contacts 3 and can contact them in the second switching state of the switching device 100. In connection with FIGS. 6A to 6C, a further embodiment for the switching device 100 is shown which, in comparison to the embodiment of FIGS. 4A to 4F, has a contact element 4 in which no bearing correctness has to be observed. The views of FIGS. 6A and 6B correspond to the views of the switching device 100 shown in FIGS. 4C and 4D, while FIG. 6C shows the contact element 4. The following description is again limited to the differences from the previous description. Features that are not explained can preferably be configured as described above.

The contact element 4 shown in FIGS. 6A to 6C has a plurality of connection bars 41, which are arranged around the contact ring 43 separated by slits 44 and extend away from the contact ring 43. A contact plate 42 is arranged on each of the connection bars 41. Furthermore, compared to the contact element 4 of the embodiment described in connection with FIGS. 4A to 4F, in which the connection bars 41 are arranged on the outer edge of the contact ring 43, the connection bars 41 are now arranged on the inner edge of the contact ring 43. Alternatively, however, the other arrangement is also possible in both embodiments.

Each connecting element 41 with contact plate 42 arranged thereon is springy as described above, so that the functionalities of the contact element 4 described above are also guaranteed in this case. The slits 44 have a width which is smaller than a width of the contact regions of the auxiliary contacts, so that with any rotations of the contact element 4 about the vertical shaft 91, i.e. with any rotations about the shaft 7, either a contact plate 42 or two adjacent contact plates 42 can always contact an auxiliary contact 3 in the second switching state of the switching device 100. The circumferentially formed contact plates 42, which are separated only by the slits 44, can thus form an almost continuous but nevertheless springy contact surface on the contact element 4. The contact plates 42 can have a curved shape as shown or alternatively be formed as described in connection with FIGS. 4A to 4F.

The features and embodiments described in connection with the figures can be combined with each other according to further embodiments, even if not all combinations are explicitly described. Furthermore, the embodiments described in connection with the figures may alternatively or additionally have further features as described in the general part.

The invention is not limited by the description based on the embodiments to these embodiments. Rather, the invention includes each new feature and each combination of features, which includes in particular each combination of features in the patent claims, even if this feature or this combination itself is not explicitly explained in the patent claims or embodiments.

1-20. (canceled)

21. A switching device comprising:
at least one fixed contact and a movable contact in a switching chamber;
a contact element outside the switching chamber;
a mechanical drive with a shaft, wherein the mechanical drive is configured for moving the movable contact and the contact element; and
at least two auxiliary contacts outside the switching chamber on a side of the shaft facing away from the movable contact,
wherein the contact element is configured to contact the at least two auxiliary contacts in a first switching state of the switching device and be spaced apart from the at least two auxiliary contacts in a second switching state of the switching device, or be spaced apart from the at least two auxiliary contacts in a first switching state of the switching device and contact the at least two auxiliary contacts in a second switching state of the switching device, and
wherein, in the first switching state of the switching device, the movable contact is at a distance from the at least one fixed contact and, in the second switching state of the switching device, the movable contact contacts the at least one fixed contact.

22. The switching device according to claim 21, wherein the contact element is at least partially springy.

23. The switching device according to claim 21, wherein the contact element is one piece.

24. The switching device according to claim 21, further comprising a gas-tight region, wherein the contact element is arranged in the gas-tight region, and wherein the at least two auxiliary contacts are arranged partly in the gas-tight region and partly outside the gas-tight region.

25. The switching device according to claim 24, wherein the at least two auxiliary contacts protrude through openings in a ceramic element, and wherein the ceramic element forms part of a wall of the gas-tight region.

26. The switching device according to claim 25, wherein the ceramic element is connected to a wall portion comprising stainless steel, and wherein the ceramic element and the wall portion together form a cup shape.

27. The switching device according to claim 21, wherein the contact element comprises a contact bar or a contact ring, wherein at least two connection bars extend away from the contact bar or contact ring, and wherein a contact plate is arranged on each of the connection bars.

28. The switching device according to claim 27, wherein the contact plates face each other.

29. The switching device according to claim 27,
wherein the contact element is arranged on an element of the mechanical drive that causes a switching movement of the movable contact,
wherein the mechanical drive has an armature with the shaft and a magnetic core and the contact element is attached directly to the magnetic core, and
wherein the contact element or the contact ring is welded to the magnetic core.

30. The switching device according to claim 29, wherein the magnetic core comprises a recess in which a part of the contact element is arranged.

31. The switching device according to claim 27, wherein the contact plates face each other and have a distance A to each other which is smaller than a width B of the auxiliary contacts.

32. The switching device according to claim 21, wherein, in the first switching state of the switching device, at least a part of the contact element is arranged laterally next to the at least two auxiliary contacts.

33. The switching device according to claim 21, wherein the contact element comprises a plurality of connection bars, which are arranged circumferentially on the contact ring separated by slits and extend away from the contact ring, and wherein a contact plate is arranged on each of the connection bars.

34. The switching device according to claim 21, wherein each of the at least two auxiliary contacts has an upper end section facing the shaft, and wherein contact plates of the contact element are arranged below the upper end sections, as seen from the shaft, irrespective of a switching state of the switching device.

35. The switching device according to claim 21, wherein each of the at least two auxiliary contacts has a contact region facing away from the shaft, and wherein each of the contact regions is mechanically contacted by a contact plate in the second switching state of the switching device.

36. The switching device according to claim 35, wherein each of the contact regions is arranged between the contact ring and the contact plate mechanically contacting the contact region, at least in the second switching state of the switching device.

37. The switching device according to claim 35, wherein each of the contact regions is in form of a conical shell.

38. The switching device according to claim 21, wherein the mechanical drive is configured to cover a path MS during a transition from the first switching state to the second switching state, and wherein the contact element is configured to obtain a mechanical contact to the at least two auxiliary contacts after a contact path KW, where KW<MS is true.

39. The switching device according to claim 21, wherein the movable contact is configured to cover a switching path SW during a transition from the first switching state to the second switching state, and wherein the contact element is configured to lose a mechanical contact to the at least two auxiliary contacts after a contact path KW, where KW/SW≤0.2 is true.

40. The switching device according to claim 21, wherein the mechanical drive has a return spring with a return spring force RFK and the contact element has a spring force FK, where FK/RFK≤0.2 is true.
